(19) United States
(12) Patent Application Publication
(10) Pub. No.: US 2004/0264995 A1
(43) Pub. Date: Dec. 30, 2004

(54) Image forming apparatus

(75) Inventor: Tatsuyuki Miura, Fujisawa-shi (JP)

Correspondence Address: FOLEY AND LARDNER, SUITE 500, 3000 K STREET NW, WASHINGTON, DC, 20007, US

(73) Assignee: KABUSHIKI KAISHA TOSHIBA and TOSHIBA TEC KABUSHIKI KAISHA

(21) Appl. No.: 10/868,975

(22) Filed: Jun. 17, 2004

(30) Foreign Application Priority Data
Jun. 27, 2003 (JP) 2003-185172

(51) Int. Cl. G03G 15/00

(52) U.S. Cl. 399/88

(57) ABSTRACT

An image forming apparatus senses a voltage value of a power supply voltage applied to a fixing unit from a power supply, determines a specification for the power supply based on the sensed voltage value of the power supply voltage, and performs control corresponding to the determined specification for the power supply.

### CROSS-REFERENCE TO RELATED APPLICATIONS

This application is based upon and claims the benefit of priority from prior Japanese Patent Application No. 2003-185172, filed Jun. 27, 2003, the entire contents of which are incorporated herein by reference.

### BACKGROUND OF THE INVENTION

1. Field of the Invention

The present invention relates to an image forming apparatus such as a copying machine using a fixing unit having a heating member of an induction heating type.

2. Description of the Related Art

Some conventional image forming apparatuses such as a copying machine need to be set in accordance with the specifications of different power supplies. In particular, an image forming apparatus using a fixing unit with a fixing roller of an induction heating type need to be controlled in accordance with the specification for a power supply. Information indicative of a specification corresponding to an image forming apparatus and control information of a fixing unit corresponding to the specification are usually written in advance to a memory in a control substrate of the main body of the image forming apparatus.

A conventional image forming apparatus causes a drawback that a voltage applied to the fixing unit does not coincide with a preset one if the apparatus is connected to a power supply whose specification differs from a preset one. In this case, parts of the image forming apparatus may be broken, and the apparatus may malfunction or decrease in performance.

### BRIEF SUMMARY OF THE INVENTION

An object of the present invention is to provide an image forming apparatus that is capable of preventing drawbacks of breakage of parts, malfunction and decrease in performance due to noncoincidence between a preset specification and a specification for a power supply to which the apparatus is actually connected.

According to an aspect of the present invention, there is provided an image forming apparatus including a fixing unit to which a power supply is connected, the apparatus comprising a voltage sensing circuit which senses a voltage value of a power supply voltage applied to the fixing unit from the power supply, a determination unit which determines a specification for the power supply based on the voltage value of the power supply voltage sensed by the voltage sensing circuit, and a control unit which performs control corresponding to the specification for the power supply determined by the determination unit.

According to another aspect of the present invention, there is provided an image forming system comprising a fixing unit to which a power supply is connected and a main control unit which controls the system, wherein the fixing unit includes a voltage sensing circuit which senses a voltage value of a power supply voltage applied from the power supply and an interface which notifies the main control unit of one of the voltage value sensed by the voltage sensing circuit and a signal indicative of a specification for the power supply, and the main control unit includes a determination unit which determines a specification for the power supply upon receiving one of the voltage value and the signal from the fixing unit and a control unit which performs control corresponding to the specification for the power supply determined by the determination unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic block diagram of an image forming apparatus according to an embodiment of the present invention.

FIG. 2 is a block diagram of a main control unit and a fixing unit in the image forming apparatus.

FIG. 3 is a bock diagram of a power supply circuit in the fixing unit.

FIG. 4 is a block diagram showing a relationship between a main unit CPU and an IH-CPU.

FIG. 5 is a table showing a relationship between power set signals and voltage values.

FIG. 6 is another table showing a relationship between power set signals and voltage values.

FIG. 7 is a table showing a relationship between values of signals H1ERR1 and H1ERR2 and error conditions.

FIG. 8 is a table showing a relationship between values of signals H1ERR1 and H1ERR2 and voltage values or specifications of power supplies.

FIG. 9 is a flowchart describing an operation of a copying machine.

### DETAILED DESCRIPTION OF THE INVENTION

An embodiment of the present invention will now be described with reference to the accompanying drawings.

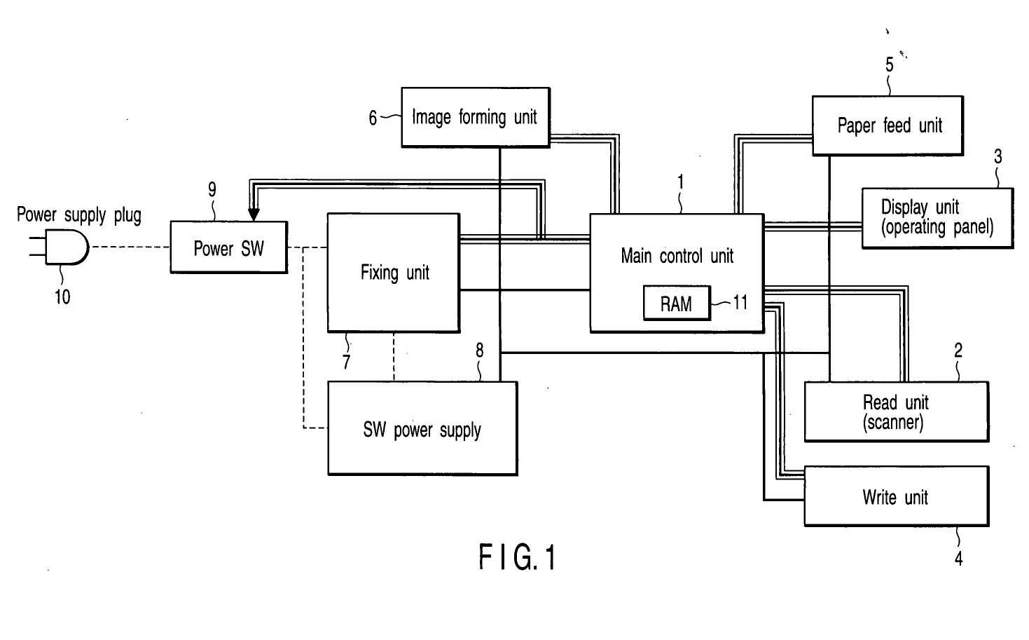

FIG. 1 is a block diagram showing an example of a copying machine (an image forming apparatus, an image forming system) using a fixing unit of an induction heating type.

As shown in FIG. 1, the copying machine comprises a main control unit 1, a read unit (scanner) 2, a display unit (operating panel) 3, a write unit (laser exposure unit) 4, a paper feed unit 5, an image forming unit (developing unit) 6, a fixing unit 7, an SW power supply 8, a power SW 9, and a power plug 10.

The main control unit 1 is responsible for the control of the copying machine in its entirety and includes a ROM for storing control programs and control data, a RAM 11 for storing various parameters, work data and the like, an image processing section for processing an image, a page memory, a hard disk drive and an external interface for carrying out data communication with an external device. Assume that the RAM 11 is a memory for holding written data or prewritten data. The RAM 11 can be provided outside the main control unit 1 and connected thereto such that the unit 1 can read/write data from/to the RAM 11.

The scanner 2 is an image read unit for capturing an image of a document as variations of light and shade and photoelectrically converting it into image data. The scanner 2 includes a CCD sensor serving as a photoelectric converting device, a CCD driver, a signal processing circuit, a scan motor, an exposure lamp, and an automatic document feeder (ADF).

The display unit (operating panel) 3 is a user interface that receives an operating instruction from a user and provides the user with various items of information. The operating panel 3 is connected to the main control unit 1 and formed of a liquid crystal display including a touch panel. The operating panel 3 displays various operating keys (icons) that can be selected by the touch panel.

The write unit (laser exposure unit) 4 irradiates a photosensitive drum (not shown) serving as an image carrying body with a laser beam to form an electrostatic latent image. In other words, the write unit 4 irradiates the outer surface of the photosensitive drum with a laser beam whose light intensity has varied with the image data to form an electrostatic latent image or an image corresponding to the image data on the outer surface of the photosensitive drum. The paper feed unit 5 receives paper as an image forming medium from a paper feed tray and carries it in the copying machine.

The image forming unit 6 has a developer section and a transfer section. The developer section supplies toner to the photosensitive drum on which an electrostatic latent image is formed by the write unit and forms a toner image thereon. The transfer section transfers the toner image onto the image forming medium. The fixing unit 7 fuses the toner on paper P by heat and at the same time applies a given pressure to the paper P to fix the toner image on the paper P. The configuration of the fixing unit 7 will be described in detail later.

The SW power supply 8 converts an AC power supply voltage that is applied through the power plug 10 and power SW 9 into various DC power supply voltages used in respective units of the copying machine. The power SW 9 is a switch for turning on/off the copying machine in its entirety. The power SW 9 is turned on/turned off by a power switch button (not shown) and its turn-on/turn-off is controlled by the main control unit 1. The power plug 10 is connected to an external AC power supply. In FIG. 1, dotted lines indicate connecting lines for AC power supply voltages, solid lines indicate connecting lines for DC power supply voltages, and triple lines indicate connecting lines for data and control signals.

The configuration of the main control unit 1 and fixing unit 7 will now be described in detail.

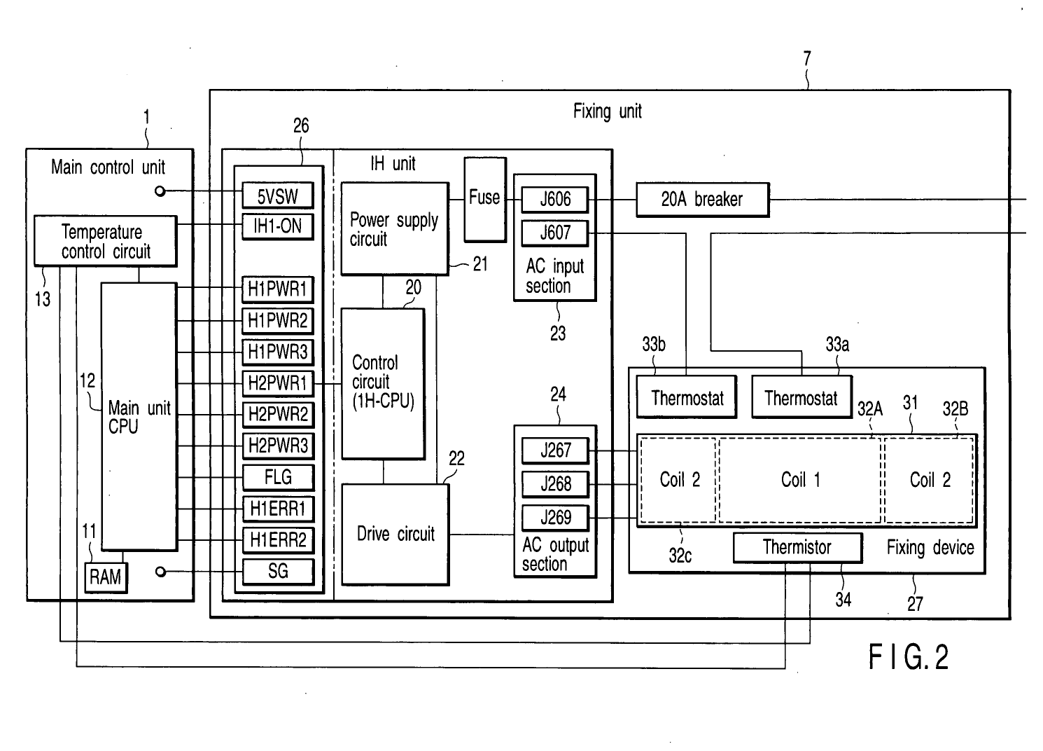

FIG. 2 is a block diagram of both the main control unit 1 and fixing unit 7.

The main control unit 1 includes a main unit CPU 12 and a temperature control circuit 13 as well as the RAM 11.

The main unit CPU 12 is responsible for the control of the respective units in the copying machine by the main control unit 1. The main unit CPU 12 is connected to the RAM 11, temperature control circuit 13, an internal interface 26 in the fixing unit 7, and the like. The temperature control circuit 13 supplies a temperature sensing signal from a thermistor 34 in a fixing device 27 of the fixing unit 7 and sends it to the main unit CPU 12.

The fixing unit 7 includes a control circuit (IH-CPU) 20, a power supply circuit 21, a drive circuit 22, an AC input section 23, and an AC output section 24 in addition to the internal interface 26 and fixing device 27.

The control circuit 20 is responsible for the control of respective sections in the fixing unit 7. Assume that the control circuit 20 has a memory that can hold written data or prewritten data.

The control circuit 20 is connected to the power supply circuit 21, drive circuit 22, internal interface 26 and the like. The power supply circuit 21 controls a power supply voltage applied to the fixing unit 7. For example, the power supply circuit 21 applies to the control circuit 20 and drive circuit 22 an AC power supply voltage that is input to the fixing unit 7 via the AC input section 23.

The drive circuit 22 applies power to the fixing device 27 through the AC output section 24. More specifically, the drive circuit 22 controls the power supplied to a plurality of coils 32 in the fixing device 27 through the AC output section 24.

The internal interface 26 supplies signals to the main control unit 1 from the control circuit 20 according to the type of signal. As shown in FIG. 2, the internal interface 26 has terminals for signals 5VSW, IH1ON, H1PWR1, H1PWR2, H1PWR3, H2PWR1, H2PWR2, H2PWR3, FLG, H1ERR1, H1ERR2 and SG. The terminal for signal IH1ON is connected to the temperature control circuit 13 of the main control unit 1, and the terminals for signals H1PWR1, H1PWR2, H1PWR3, H2PWR1, H2PWR2, H2PWR3, FLG, H1ERR1 and H1ERR2 are connected to the main unit CPU 12 of the main control unit 1. A relationship in connection between the main control unit 1 and the fixing unit 7 through the internal interface 26 will be described in detail later.

The fixing device 27 has a fixing roller 31 and a pressure roller (not shown). The coils 32 (32A, 32B and 32C) are provided in the fixing roller 31, and thermostats 33 (33a and 33b) and thermistor 34 are provided on the surface of the fixing roller 31. A separation claw (not shown) for separating paper from the fixing roller 31, a cleaning member (not shown) for eliminating toner and waste paper from the fixing roller 31, and a coating roller (not shown) for coating the surface of the fixing roller 31 with a release agent are arranged around the fixing roller 31.

The fixing roller 31 is formed by shaping conductive materials such as iron cylindrically and its outer surface is coated with, e.g., fluorocarbon resin such as ethylene tetrafluoride. The fixing roller 31 is rotated in the right direction in FIG. 2 by a drive motor (not shown).

The pressure roller is pressed in contact with the outer surface of the fixing roller 31 by a pressure mechanism (not shown). The pressure roller rotates in the left direction in FIG. 2 as the fixing roller 31 does. When a copying paper sheet S passes through a contact portion between the fixing roller 31 and the pressure roller and receives heat from the fixing roller 31, a developer image T is fixed on the copying paper sheet S.

The coils 32 in the fixing roller 31 are of an induction heating type. The coils 32 receive high-frequency power from the drive circuit 22 through the AC output section 24 and generate an induction heating high-frequency magnetic field. Thus, the fixing roller 31 causes an overcurrent and generates heat by Joule heat due to the overcurrent.

There now follows an explanation of a circuit arrangement of the power supply circuit 21 of the fixing unit 7.

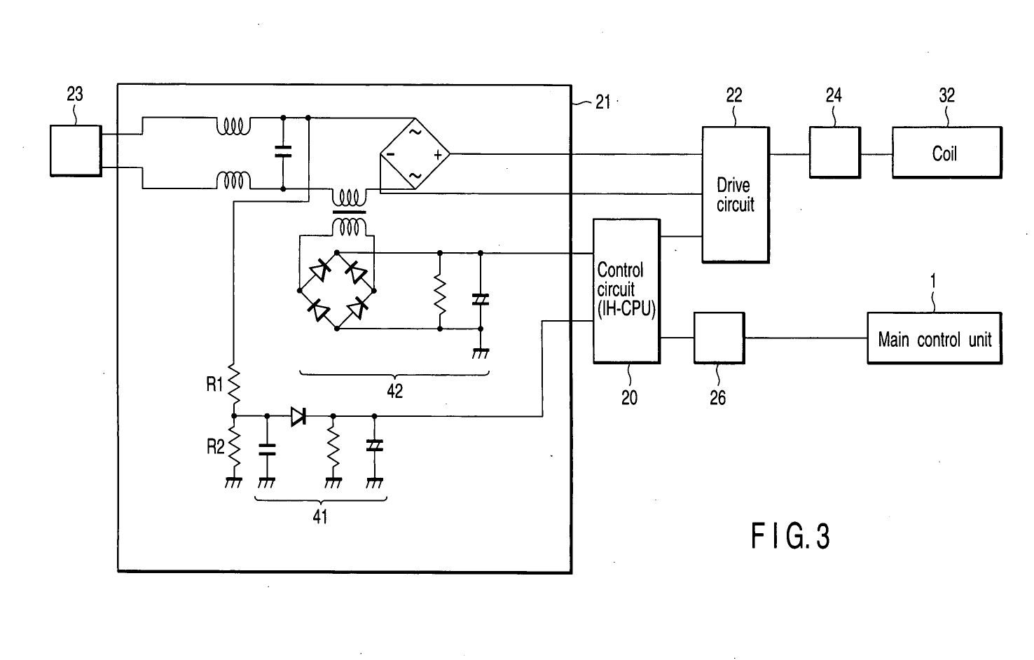

FIG. 3 is a block diagram showing an example of the circuit arrangement of the power supply circuit 21 in the fixing unit 7.

Referring to FIG. 3, the power supply circuit 21 includes a voltage sensing circuit 41 and a current sensing circuit 42. Both the sensing circuits 41 and 42 sense power consumed by the coils 32 in the fixing device 27.

The voltage sensing circuit 41 receives a power supply voltage (AC voltage applied to the drive circuit 22) from a power cord through the AC input section 23 and divides it by resistors R1 and R2. Then, the circuit 41 rectifies the divided voltage by a diode, a capacitor and a resistor. The rectified voltage is read by an analog board of a CPU in the control circuit 20. Thus, the control circuit 20 determines (senses) a voltage value of the power supply voltage.

If the read voltage is 0V, the control circuit 20 determines that the power supply voltage is AC 0V. If it is 2V, the power supply voltage is AC 100V. If it is 5V, the power supply voltage is AC 250V.

The voltage sensing circuit 42 receives a power supply current (current supplied to the drive circuit 22) from a power cord through the AC input section 23 and rectifies it by a diode bridge, a resistor and a capacitor through a pulse transformer. The rectified current is read by the analog board of the CPU in the control circuit 20. Thus, the control circuit 20 determines (senses) a current value of the power supply current.

If the read current is 0V, the control circuit 20 determines that the current value is AC 0A. If it is 2V, the current value is AC 10A. If it is 5V, the current value is AC 25A.

Based on the voltage and current values so determined, the control circuit 20 computes power of the coils 32 and controls the drive circuit 22 such that the power has a desirable set value.

A relationship in connection between the main control unit 1 and the fixing unit 7 will be described in detail.

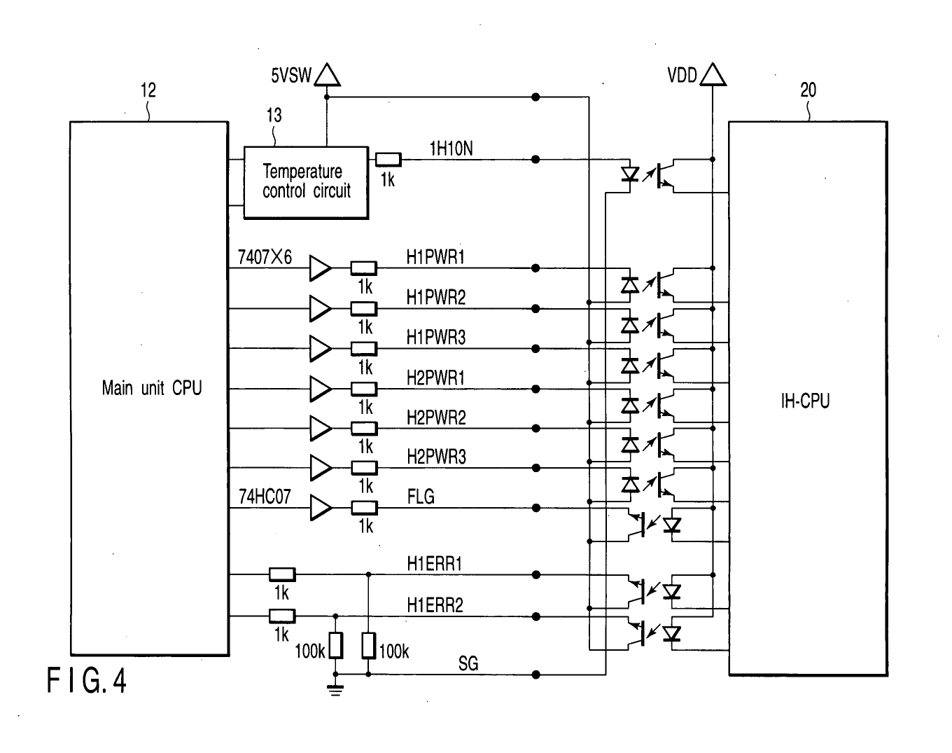

FIG. 4 is a block diagram showing a relationship in connection between the main control unit 1 and the fixing unit 7.

Referring to FIG. 4, the temperature control circuit 13 of the main control unit 1 and the control circuit of the fixing unit 7 are connected to each other by a signal line for signal IH1ON. The signal IH1ON is a signal for controlling the turn-on/turn-off of the coils 32. In other words, the temperature control circuit 13 controls the turn-on/turn-off of the coils 32 such that the surface of the fixing roller 31 is set at a desired temperature (e.g., 200° C.) in response to a temperature sensing signal from the thermistor provided on the surface of the fixing roller 31.

As shown in FIG. 4, the main unit CPU 12 of the main control unit 1 and the control circuit 20 of the fixing unit 7 are connected to each other by signal lines for signals H1PWR1, H1PWR2, H1PWR3, H2PWR1, H2PWR2, H2PWR3, FLG, H1ERR1 and H1ERR2.

The signals H1PWR1, H1PWR2, H1PWR3, H2PWR1, H2PWR2 and H2PWR3 (hereinafter referred to as power set signals) are signals for setting a value of power applied to the coils 32.

The power value is set on the basis of the specification for a power supply. A power supply voltage varies among Japan, North America, Europe and the like and so does a value of power applied to the coils 32. If the specification is directed to Japan, the power value is set at 700 W in standby mode and at 1000 W in both warm-up and printing modes. If the specification is directed to North America and Europe, the power value is set at 900 W in standby mode and at 1700 W in both warm-up and printing modes.

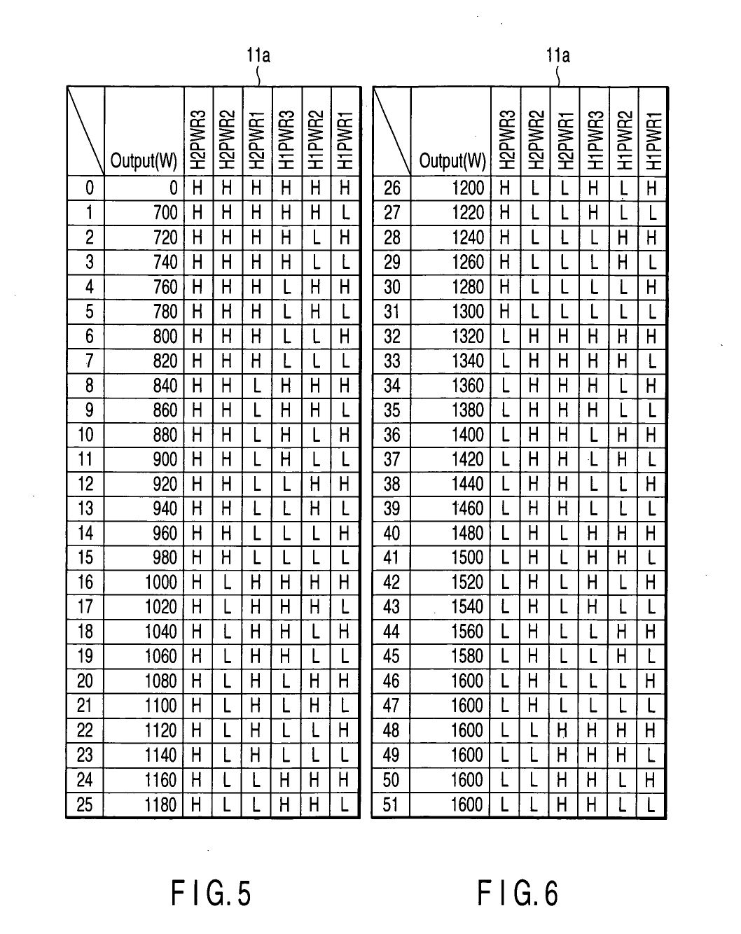

FIGS. 5 and 6 are tables each showing an example in which power values are set by the above power set signals.

As shown in FIGS. 5 and 6, values of power applied to the coils 32 are set by combinations of six power set signals H1PWR1, H1PWR2, H1PWR3, H2PWR1, H2PWR2 and H2PWR3. Setting information indicative of a relationship between the power set signals and the power values as shown in FIGS. 5 and 6 is stored in a memory (not shown) in the control circuit 20 as well as the RAM 11.

According to the tables shown in FIGS. 5 and 6, when a value of power applied to the coils 32 is set at 700 W, the main unit CPU 12 sets the signals H1PWR1, H1PWR2, H1PWR3, H2PWR1 and H2PWR2 at H(1) and sets the signal H2PWR3 at L(0). When a value of power applied to the coils 32 is 1000 W, the main unit CPU 12 sets the signals H1PWR1, H1PWR3, H2PWR1, H2PWR2 and H2PWR3 at H(1) and sets the signal H1PWR2 at L(0).

The signals H1ERR1 and H1ERR2 represent the status of the fixing unit 7. These signals are transmitted to the main unit CPU 12 from the control unit 20 and their significance is varied with the signal FLG as an identification signal. In other words, information transmitted by the signals H1ERR1 and H1ERR2 depends upon the value of the signal FLG.

When the signal FLG is L(0), the signals H1ERR1 and H1ERR2 serve as signals (error notification signals) to notify the main unit CPU 12 of error conditions in the fixing unit 7. When the signal FLG is H(1), the signals H1ERR1 and H1ERR2 serve as signals to notify the main unit CPU 12 of the specification for a power supply from which a power supply voltage is applied to the fixing unit 7.

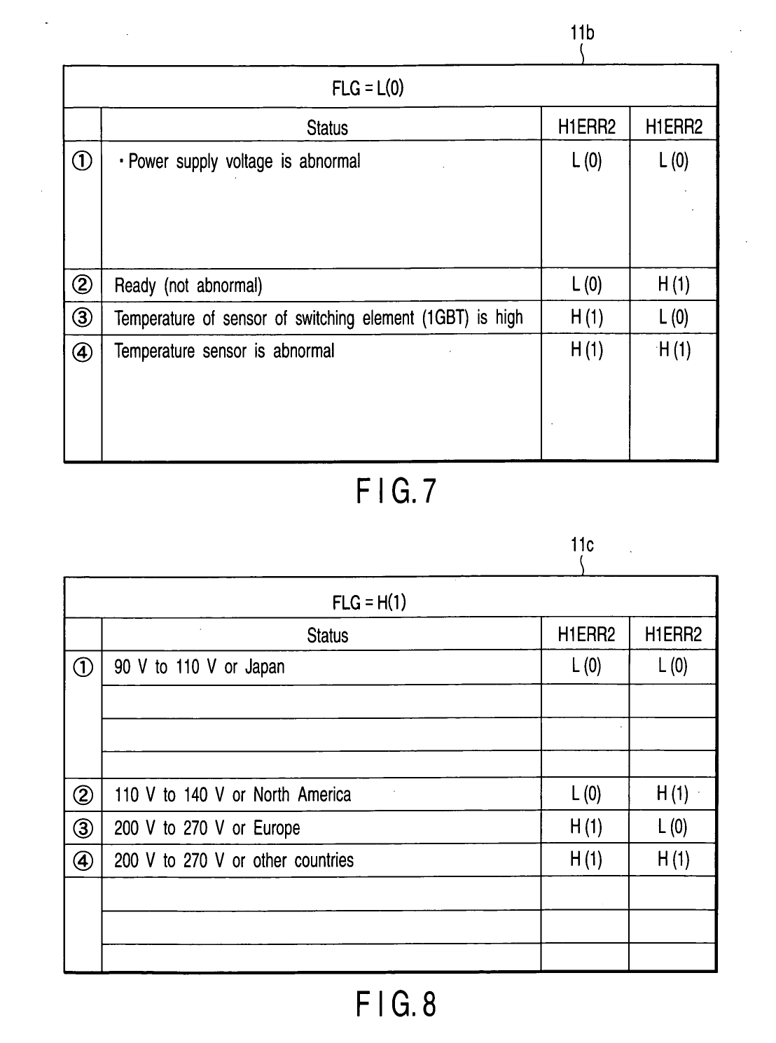

FIG. 7 shows an example of information transmitted through the signals H1ERR1 and H1ERR2 when the signal FLG is L(0). In this example, information indicative of a relationship between the signals H1ERR1 and H1ERR2 and error conditions is stored in advance in a memory (not shown) in the control circuit 20 as well as the RAM 11.

The example of FIG. 7 shows that the power supply voltage applied to the fixing unit 7 is abnormal when the signals FLG, H1ERR1 and H1ERR2 are set at L(0).

The example of FIG. 7 shows that the fixing unit 7 is in a ready state (not abnormal) when the signals FLG and H1ERR1 are set at L(0) and the signal H1ERR2 is set at H(1).

The example of FIG. 7 shows that the temperature of the sensor of a switching element is high when the signals FLG and H1ERR2 are set at L(0) and the signal H1ERR1 is set at H(1).

The example of FIG. 7 shows that the temperature sensor in the fixing unit 7 is abnormal when the signal FLG is set at L(0) and the signals H1ERR1 and H1ERR2 are set at H(1).

FIG. 8 shows an example of information transmitted through the signals H1ERR1 and H1ERR2 when the signal FLG is H(1). In this example, information indicative of a relationship between the signals H1ERR1 and H1ERR2 and a power value or a specification for a power supply is stored in advance in a memory (not shown) in the control circuit 20 as well as the RAM 11.

The example of FIG. 8 shows that the power supply voltage applied to the fixing unit 7 is 90V to 110V or the specification for a power supply is directed to Japan when the signal FLG is set at H(1) and the signals H1ERR1 and H1ERR2 are set at L(0).

The example of FIG. 8 shows that the power supply voltage applied to the fixing unit 7 is 110V to 140V or the specification for a power supply is directed to North America when the signals FLG and H1ERR2 are set at H(1) and the signal H1ERR1 is set at L(0).

The example of FIG. 8 shows that the power supply voltage applied to the fixing unit 7 is 200V to 270V or the specification for a power supply is directed to Europe when the signals FLG and H1ERR1 are set at H(1) and the signal H1ERR2 is set at L(0).

The example of FIG. 8 shows that the power supply voltage applied to the fixing unit 7 is 200V to 270V or the specification for a power supply is directed to the countries other than Japan, North America and Europe when the signals FLG, H1ERR1 and H1ERR2 are set at H(1).

There now follows an explanation of an operation of the copying machine according to the embodiment of the present invention.

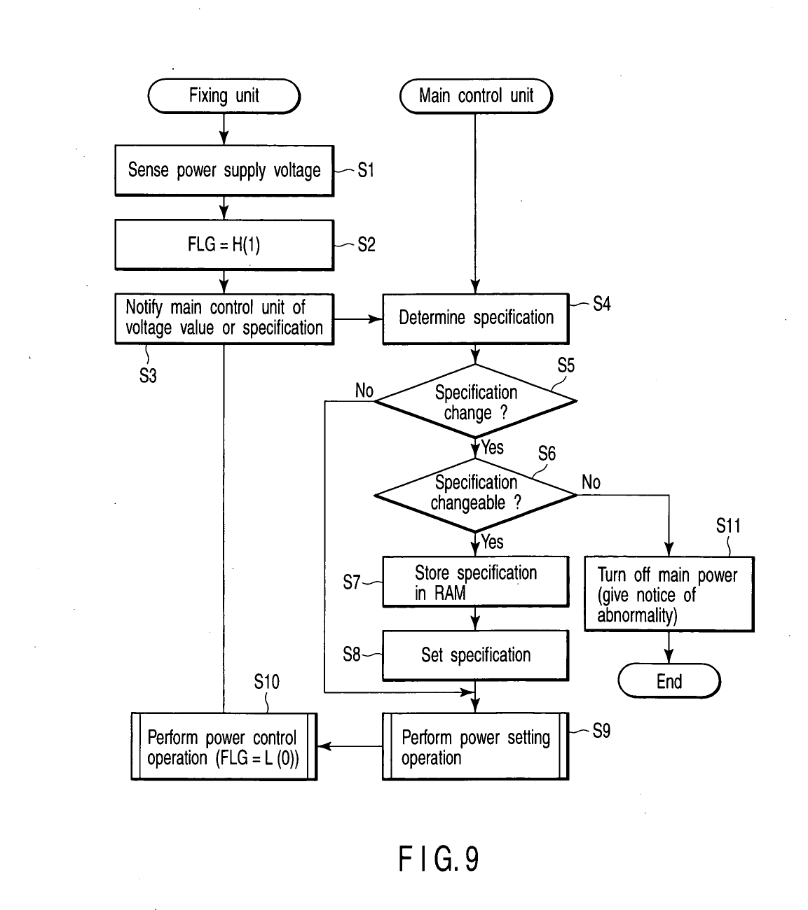

FIG. 9 is a flowchart illustrating an operation of the copying machine.

Assume that an operation shown in FIG. 9 is performed each time the power SW 9 turns on. This operation can be done at regular time intervals. Also, assume that the RAM 11 stores the setting contents of respective units of the copying machine, which correspond to the specification for a power supply.

When a user turns on a main power switch button (not shown) of the copying machine, the power SW 9 turns on. Thus, a power supply (not shown) applies a power supply voltage to the power supply circuit 21 in the fixing unit 7 through the power plug 10 and the AC input section 23 in the fixing unit 7. Then, the voltage sensing circuit 41 in the power supply circuit 21 rectifies the power supply voltage and supplies it to the control circuit 20 (step S1).

The control circuit 20 determines a voltage value of the power supply voltage and then sets a value of the signal FLG at H(1) (step S2). In this condition, the control circuit 20 sets values of the signals H1ERR1 and H1ERR2 at the above voltage value or a value indicative of the specification corresponding to the voltage value based on the table as shown in FIG. 8.

If the signals FLG, H1ERR1 and H1ERR2 are set at the voltage value of the power supply voltage or the value of the specification as described above, the internal interface 26 sends these signals to the main control unit 1 (step S3).

The main unit CPU 12 of the main control unit 1 receives the signals FLG, H1ERR1 and H1ERR2. The main unit CPU 12 determines a voltage value or a specification for a power supply voltage by combinations of the signals FLG, H1ERR1 and H1ERR2 (step S4). This determination is based on the table stored in the RAM 11 as shown in FIG. 8.

The main unit CPU 12 compares the determined specification with information indicative of the specification that have already been stored in the RAM 11 (specification information stored in advance or specification information determined when the power supply turned on the last time) (step S5).

If both the specifications do not coincide with each other (YES in step S5), the main unit CPU 12 determines whether a specification can be changed to the specification (specification for the currently connected power supply) determined in step S4 (step S6). Assume that the setting contents of the respective units in the copying machine corresponding to several specifications adaptable to the copying machine are stored in the RAM 11 or the like. When the copying machine is adapted to only one preset specification, no setting contents corresponding to other specifications are stored in the RAM 11 (the preset specification cannot be changed to another one).

When the main unit CPU 12 determines that a specification can be changed to that for a power supply to which the copying machine is currently connected (YES in step S6), it stores information indicative of the specification for the power supply in the RAM 11 (step S7) and changes the respective units of the copying machine to the specification (step. S8).

After that, the main unit CPU 12 performs a power setting operation (normal operation) for the fixing unit 7 (step S9).

When the specification for the power supply coincides with that stored in the RAM 11 in step S5, the main unit CPU 12 performs a power setting operation for the fixing unit 7 (step S9).

In accordance with the power set by the main control unit 1, the fixing unit 7 performs a power control operation (normal operation) (step S10). The control circuit 20 monitors error conditions in the fixing unit 7 during the power control operation. If the control circuit 20 senses an error during the power control operation, it notifies the main unit CPU 12 of information indicative of the condition of the error with the signal FLG at L(0).

When the main unit CPU 12 determines that a specification cannot be changed to that for a power supply to which the copying machine is currently connected (NO in step S6), it turns off the power SW 9 and then the main power switch of the copying machine (step S11). The main unit CPU 12 can display on the display unit 3 the fact that the specification for a power supply is inadequate for the copying machine currently connected to the power supply.

The RAM 11 can store in advance specification information corresponding to the specification for the copying machine at the time of manufacture.

If a copying machine with the RAM 11 storing the specification information or a copying machine including a control substrate with the RAM 11 storing the specification information turns on, it is possible to determine whether the specification information stored in the RAM 11 coincides with the specification for a power supply, which corresponds to the specification information from the fixing unit. If the specification information stored in the RAM 11 does not coincide with that for the power supply, the main unit CPU 12 can notify, for example, the display unit 3 of the noncoincidence.

It is therefore possible to detect and notice that the RAM 11 or a control substrate with the RAM 11 is placed in the copying machine by mistake.

As described above, according to the embodiment of the present invention, a voltage value of a power supply voltage applied to the fixing unit from the power supply is sensed, the specification for the power supply is determined based on the detected voltage value, and control is performed in accordance with the determined specification.

Consequently, the copying machine can be set in accordance with the specification for a power supply. The copying machine can prevent drawbacks of breakage of parts, malfunction and decrease in performance due to noncoincidence between a preset specification and a specification for a power supply to which the machine is actually connected.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image forming apparatus including a fixing unit to which a power supply is connected, the apparatus comprising:
a voltage sensing circuit which senses a voltage value of a power supply voltage applied to the fixing unit from the power supply;
a determination unit which determines a specification for the power supply based on the voltage value of the power supply voltage sensed by the voltage sensing circuit; and
a control unit which performs control corresponding to the specification for the power supply determined by the determination unit.

2. The image forming apparatus according to claim 1, wherein the voltage sensing circuit is included in a power control circuit of the fixing unit.

3. The image forming apparatus according to claim 1, wherein the control unit sets a specification for the image forming apparatus based on the specification for the power supply determined by the determination unit.

4. The image forming apparatus according to claim 1, wherein the determination unit determines a specification for a power supply to which the fixing unit is connected, each time a power switch of the image forming apparatus turns on.

5. The image forming apparatus according to claim 1, wherein the determination unit determines a specification for a power supply to which the fixing unit is connected, at regular time intervals.

6. The image forming apparatus according to claim 1, further comprising a memory which stores information indicative of a specification for the image forming apparatus in advance, and
wherein the control unit compares the specification determined by the determination unit and the information stored in the memory and gives a notice of noncoincidence when the specification and the information do not coincide with each other.

7. The image forming apparatus according to claim 1, further comprising a memory which stores information indicative of the specification for the power supply determined by the determination unit, and
wherein the control unit compares the specification determined by the determination unit and the information stored in the memory and turns off a power switch of the image forming apparatus when the specification and the information do not coincide with each other.

8. The image forming apparatus according to claim 7, wherein the determination unit determines a specification for a power supply to which the fixing unit is connected, each time the power switch of the image forming apparatus turns on.

9. The image forming apparatus according to claim 7, wherein the determination unit determines a specification for a power supply to which the fixing unit is connected, at regular time intervals.

10. An image forming system comprising a fixing unit to which a power supply is connected and a main control unit which controls the system,
wherein the fixing unit includes:
a voltage sensing circuit which senses a voltage value of a power supply voltage applied from the power supply; and
an interface which notifies the main control unit of one of the voltage value sensed by the voltage sensing circuit and a signal indicative of a specification for the power supply, and
the main control unit includes:
a determination unit which determines a specification for the power supply upon receiving one of the voltage value and the signal from the fixing unit; and
a control unit which performs control corresponding to the specification for the power supply determined by the determination unit.

11. The image forming system according to claim 10, wherein the voltage sensing circuit of the fixing unit is included in a power control circuit of the fixing unit.

12. The image forming system according to claim 10, wherein the control unit of the main control unit sets a specification for the image forming apparatus based on the specification for the power supply determined by the determination unit.

13. The image forming system according to claim 10, wherein the fixing unit notifies the main control unit of one of the voltage value of the power supply voltage sensed by the voltage sensing circuit and the signal indicative of the specification for the power supply by the interface each time a power switch of the image forming system turns on.

14. The image forming system according to claim 10, wherein the fixing unit notifies the main control unit of one of the voltage value of the power supply voltage sensed by the voltage sensing circuit and the signal indicative of the specification for the power supply by the interface at regular time intervals.

15. The image forming system according to claim 10, wherein the main control unit includes a memory which stores information indicative of the specification for the image forming system in advance, and the control unit of the main control unit compares the specification determined by the determination unit and the information stored in the memory and gives a notice of noncoincidence when the specification and the information do not coincide with each other.

16. The image forming system according to claim 10, wherein the main control unit includes a memory which stores information indicative of the specification for the power supply determined by the determination unit, and the control unit of the main control unit compares the specification determined by the determination unit and the information stored in the memory and turns off a power switch of the image forming system when the specification and the information do not coincide with each other.

17. The image forming system according to claim 16, wherein the fixing unit notifies the main control unit of one of the voltage value of the power supply voltage sensed by the voltage sensing circuit and the signal indicative of the specification for the power supply by the interface each time the power switch of the image forming system turns on.

18. The image forming system according to claim 16, wherein the fixing unit notifies the main control unit of one of the voltage value of the power supply voltage sensed by the voltage sensing circuit and the signal indicative of the specification for the power supply by the interface at regular time intervals.

19. A method of controlling an image forming apparatus including a fixing unit to which a power supply is connected, the method comprising:
sensing a voltage value of a power supply voltage applied to the fixing unit from the power supply;
determining a specification for the power supply based on the sensed voltage value of the power supply voltage; and
performing control corresponding to the determined specification for the power supply.

20. The method according to claim 19, wherein the control performing includes setting a specification for the image forming apparatus based on the determined specification for the power supply.
